(19) United States
(12) Patent Application Publication
(10) Pub. No.: US 2008/0255709 A1
(43) Pub. Date: Oct. 16, 2008

(54) INTELLIGENT ELECTRONIC DEVICE FOR SUBSTATION OR DISTRIBUTION AUTOMATION SYSTEMS

(75) Inventors: Lennart Balgard, Arboga (SE); Vijay Shah, Baroda Gujarat (IN); Bernhard Deck, Weiheim (DE); Paul Rudolf, Villigen (CH)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD, Zurich (CH)

(21) Appl. No.: 12/102,545

(22) Filed: Apr. 14, 2008

(30) Foreign Application Priority Data
Apr. 16, 2007 (EP) 07106249.1

(51) Int. Cl. G05F 5/00

(52) U.S. Cl. 700/292

(57) ABSTRACT

According to the present disclosure, an Intelligent Electronic Device (IED) such as a digital relay or protection device for Substation or Distribution Automation is conceived in a modular way, comprising distinct modules dedicated to distinct tasks and having dedicated housings or casings, which modules are mechanically arranged on a common support and both visible and accessible from outside of the IED at all times. Modules for signal input (process interface modules comprising a number of input terminals and signal processing (process data handling modules for evaluating signals in view of an automated protection function or as a communication gateway) define the basis of a modular arrangement that is not delimited by any prefabricated cover or cabinet and that allows for a quasi-unlimited flexibility regarding the number of modules and an easy replacement or extension of individual modules.

### RELATED APPLICATION

This application claims priority under 35 U.S.C. §119 to European Patent Application No. 07106249.1 filed in the European Patent Office on 16 Apr. 2007, the entire content of which is hereby incorporated by reference in its entirety.

### TECHNICAL FIELD

The disclosure relates to the field of automated power transmission and distribution systems. It departs from a digital device for Substation Automation (SA) or Distribution Automation (DA) systems as described in the preamble of claim 1.

### BACKGROUND INFORMATION

An electric power system comprises a power transmission and/or distribution network interconnecting geographically separated regions, and a plurality of substations at the nodes of the power network. The substations include equipment for transforming voltages and for switching connections between individual lines of the power network. They comprise primary devices such as electrical cables, lines, bus bars, switches (breakers or disconnectors), power transformers and instrument transformers which are generally arranged in switch yards and/or bays. These primary devices are operated in an automated way via a Substation Automation (SA) or Distribution Automation (DA) system responsible for controlling, protecting, measuring and monitoring of substations. The automation system comprises secondary devices interconnected in a SA communication network and interacting with the primary devices via a process interface.

In automated power transmission and distribution, the secondary devices comprise microprocessor-based programmable electronic devices or digital relays that are capable of sending control signals to switching devices, such as circuit breakers and disconnectors. Most digital relays in use today combine protection, control, monitoring, communications, power quality monitoring, and metering capabilities. The protection functions supported by a digital relay may include time delay and instantaneous over-current functions for phase and ground elements, sequence directional over-current functions, reclosing functions, over- and under-frequency protection functions, and over- and under-voltage protection functions. Digital relays also support various metering functions; monitoring of voltage sags, swells, and interruptions; fault location algorithms; and oscillographic record storage, and are configured locally using the front panel of the protection device or remotely using a settings software tool. In many cases the required protection functionality is preloaded in the device, and later enabled and parameterised with a tool connected to the protection device. Without this tool or other human machine interface however, a user can not discern what function the device has actually programmed or enabled.

In short, a basic function of these protection devices is to protect electrical equipment by tripping a circuit breaker and interrupting a power line. The tripping signal is generated by the digital relay typically when the measured current in the line exceeds a nominal or setting value for a predefined time period.

The protection devices described above may have different kinds of interfaces depending on the intended application. The interfaces are binary inputs, binary outputs, analog inputs, analog outputs, communication interfaces, power supplies, trip indicators, human machine interfaces and also SW functions. The analog inputs are typically connected to different sensor types and primary transducer means placed on the power line, such as current transformers (CT) and voltage transformer (VT), or non-conventional transducer means like Rogowski coils, Hall sensors and voltage dividers.

Standard digital protection devices in the field of automated power transmission and distribution systems are designed semi-modular and use a single electrically insulating cover or cabinet to enclose all the modules. However, employing a cover of given dimensions ultimately limits the number of modules, constrains their mutual arrangement and complicates replacement or extension of individual modules.

The process automation industry uses so-called modular remote Input/Output (I/O) systems for controlling industrial processes. To the purpose of remote signal processing, the company Moeller GmbH (www.moeller.net), in their catalogue “Automation Product Overview”, 2005, pages 66-69, offers a range of digital and analog I/O and technology modules. Typically, the analog I/O modules are restricted to current signals between 4 and 20 mA and to voltage signals between −10 and +10 VDC. The modules are to be mounted on an inverted hat rail as a mechanical support. The modules are linked, via an internal module bus, to each other and, via gateways, to different field bus systems and to a centralized operator work station. Power feeding modules supply I/O modules with a rated voltage of up to 230 V, hence an electrical insulation withstanding 500 V at the analog inputs is sufficient. However, these systems have been developed for and adapted to the needs of process automation in industrial applications, and their use in a substation for electrical power distribution with voltage levels in excess of 1 kV and the stringent environmental requirements (humidity, dust, low temperatures) is not envisaged.

Substation automation systems require interoperability between all substation devices independently of their manufacturer. To that effect, an internationally accepted communication standard for communication between the secondary devices of a substation has been introduced under the name of IEC 61850 “communication networks and systems in substations”. IEC 61850 defines an abstract object model for compliant substations, and a method how to access these objects over a network. The abstract object model represents the functionality in terms of logical nodes within logical devices that in turn are allocated to the protective devices as the physical devices. The actual communication between the devices is handled, for non-time critical messages, via an MMS communication stack built on OSI/TCP/IP/Ethernet, or for time critical messages, via so-called Generic Object Oriented Substation Events (GOOSE) that build directly on the Ethernet link layer of the communication stack. All IEC 61850 compliant secondary devices connected to the SA communication network, including but not limited to digital relays as introduced above, are called Intelligent Electronic Devices (IED).

The IEC 61850 Substation Configuration Language (SCL) provides for a standardized description of the primary devices, the secondary devices with their Protection, Control and Monitoring (PCM) functions, the communication system logical structure and the relation between primary and secondary devices, including data attributes carried by the instances related to particular devices, e.g. values for configuration attributes and setting parameters. A Substation Configuration Description (SCD) file in SCL language describes, for a particular substation, the primary objects, the functions implemented in each protective device in terms of logical nodes, and the communication connections. The connection between the power process and the SA system is described in the SCL language by allocating or attaching logical nodes to elements of the primary equipment. Typically, a switch control logical node is attached to a switching device, whereas a measurement logical node is allocated to an instrument transformer.

### SUMMARY

Exemplary embodiments disclosed herein can create secondary devices for Substation Automation (SA) or Distribution Automation (DA) which are flexible and which can be easily extended and maintained. An Intelligent Electronic Device (IED) and an input module are disclosed.

An Intelligent Electronic Device (IED) for Substation Automation (SA) or Distribution Automation (DA) systems is disclosed, comprising an input module (20) for receiving a signal indicative of a condition of a high or medium voltage power line and a processing module for digitally processing the signal, wherein the input module and the processing module are individually mountable on a mechanical support, and in that the input module and the processing module comprise dedicated housings that, when the modules are mounted on the mechanical support, together form a housing of the IED.

An input module to be used in a modular Intelligent Electronic Device (IED) for Substation Automation (SA) or Distribution Automation (DA) systems is disclosed, having a voltage isolation in excess of 2 kV between a signal input terminal and Protective Earth (PE).

### BRIEF DESCRIPTION OF THE DRAWINGS

The subject matter of the disclosure will be explained in more detail in the following text with reference to exemplary embodiments which are illustrated in the attached drawings, in which:

FIG. 1 shows an exemplary Intelligent Electronic Device (IED) with three modules; and

FIG. 2 depicts the IED with a function key attached to an exemplary processing module of the IED.

The reference symbols used in the drawings, and their meanings, are listed in summary form in the list of reference symbols. In principle, identical parts are provided with the same reference symbols in the figures.

### DETAILED DESCRIPTION

According to the disclosure, an Intelligent Electronic Device (IED) such as a digital relay or protection device for Substation or Distribution Automation is conceived in a modular way, comprising distinct modules dedicated to distinct tasks and having dedicated housings or casings, which modules are mechanically arranged on a common support and both visible and accessible from outside of the IED at all times. Modules for signal input (process interface module) and signal processing (process data handling module) define the basis of a modular arrangement that is not delimited by any prefabricated cover or cabinet and that allows for a quasi-unlimited number of modules, and easy replacement or extension of individual modules.

The basic input functionality is provided by a binary or analogue input module comprising a number of input terminals and some signal conditioning facility for converting, storing, or time-stamping the input signal. The basic processing functionality is provided by a protection module for evaluating the signal in view of an automated protection function, or a communication gateway for communicating the signal to a substation bus. In the latter case, the IED represents an intelligent decentralized process interface, comprising an arbitrarily extendable number of I/O modules and the gateway connecting to a centralized computer for carrying out the protection functionality.

Besides the basic modules mentioned, the IED may comprise any number of other modules with each a dedicated functionality, such as binary output, analogue output e.g. for producing a trigger signal on behalf of an actuator, power supply, trip indicator, or human machine interface. The modules can be placed on the mechanical support in an arbitrary order and the sum of the modules defines the function of the IED.

In a first exemplary embodiment, considering the fact that the intended application in Substation or Distribution Automation by definition involves voltage levels above 1 kV, the signal input terminals, i.e. the screw or clamp connectors for the wires coming from the sensor, are such as to ensure a voltage insulation between two terminals, and/or between a terminal and Protective Earth (PE), of at least 2 kV. As a consequence, the internal circuitry on a PCB of the module is advantageously arranged such as to respect a lateral separation of at least 4 mm in order to prevent surface leakage currents.

The different modules of the IED are connected via an inter-module bus for inter-module communication. In a second exemplary embodiment, the latter involves, as the physical communication media, a segmented backplane that is created on-site by placing the individual modules next to each other and establishing an electrical contact between the parts or segments of the backplane that are incorporated in the different individual modules. This avoids the need for an additional manufacturing step consisting of the mounting of a non-segmented backplane, such as a wave guide or optical fibre, either on the mechanical support or on the top, front or bottom side of the mounted modules, and further contributes to an enhanced flexibility.

In a third exemplary embodiment, all or some of the modules are constructed in such a way that an electronic part or electronic sub-module can be exchanged without removing the cabling or cable installation of the module. To this end, all cable terminals of one module are grouped to a base part or base sub-module that is directly mounted on the mechanical support, whereas the electronic part is confined in a dedicated housing that itself is plugged to the base part. As in general the electronic parts have a lower Mean Time Between Failure (MTBF) than the mechanical parts, the base part may remain in place during maintenance operations directed to the electronic parts. In the present context, the electronic or intelligent part of the I/O modules comprises the signal conditioning facility, i.e. an A/D or D/A converter for analogue I/Os connected to an instrument transformer or a gas density or other sensor or actuator, or a time-stamping and data storage means for binary I/Os continuously monitoring or providing/outputting a binary signal, registering changes and indicating a quality status. On the other hand, the terminals of a processing module assigned to the base part are e.g. an interface to an HMI or sockets for function coding or activation keys as detailed next.

In an advantageous variant of the disclosure, a processing module comprising a CPU is further adapted for receiving function coding or activation keys. The latter may be inserted into or otherwise coupled to the processing module and in particular cooperate with a dedicated socket in the base sub-module. They enable a single one or a set of protection function(s) by activating, upon transfer of an activation code from the key, a preloaded function or by injecting the function as a piece of executable software code. At the same time, the keys act as visual indicators for a user who has access to the IED and can tell at a glance which functions have been enabled. In particular, such a coding may be established by using keys of different colour, preferably luminescent to be visible also in the dark, or by using graphical symbols or IEC 61850 Logical Node designations related to the enabled functions.

In terms of IEC 61850, a Logical Node (LN) is part of a logical device that is itself allocated to an IED. In other words, conventionally the main CPU at the processing module of the IED can be said to host the logical device with all the LNs. Contrary thereto, in a further advantageous variant, a Logical Node (LN) representing the functionality of a particular module is allocated to the respective module as the physical sub-device, i.e. the electronic part of the particular module hosts or represents the LN. In this case, the module itself acts as a server and can be polled, e.g. by the processing module, for the attributes of the LN via the inter-module bus. By way of example, the XML excerpt below represents an instance of a data acquisition Logical Node (TVTR) of a voltage transformer (VTR), with four attributes or data objects (DO).

<LNodeType id=“TVTRa” lnClass=“TVTR”>

<DO name=“Mod” type=“myMod”/>

<DO name=“Health” type=“myHealth”/>

<DO name=“Beh” type=“myBeh”/>

<DO name=“Vol” type=“mySAV”/>

</LNodeType>

An IED with IEC 61850 compatible input modules can then be used in combination with a communication module as a remote intelligent I/O, preferably using the GOOSE-communication method defined in IEC 61850.

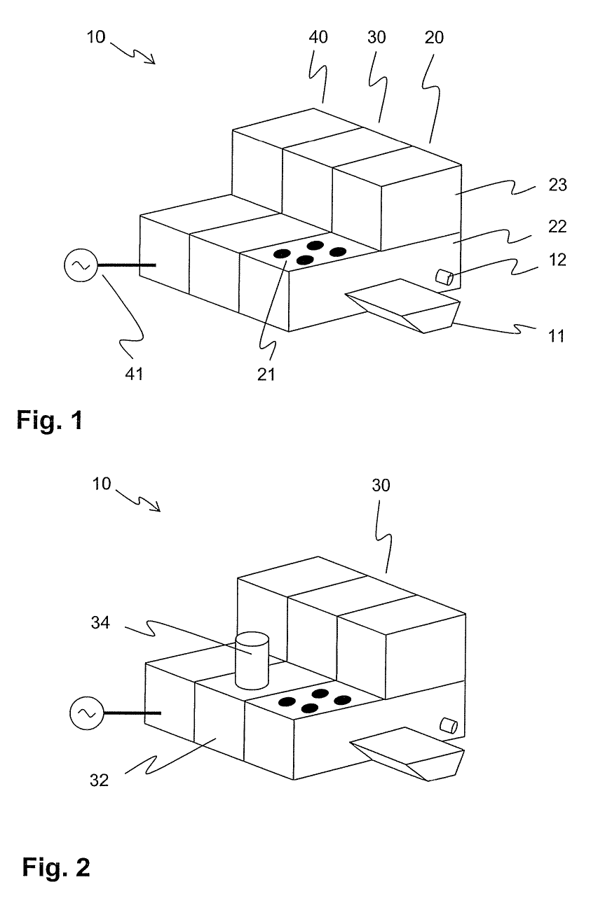

FIG. 1 shows an Intelligent Electronic Device (IED) 10 with an I/O module 20, a processing module 30 and a power supply module 40. The modules each comprise a flat housing with a predominant lateral surface and a small front and top side. When mounted on a mechanical support 11, the modules are arranged next to each other and in contact via their respective lateral surfaces. Appropriate openings and contacts in the lateral surfaces allow an inter-module backplane 12 to be established. The housings of the modules form the casing of the IED, i.e. there is no further cover enclosing the modules. The I/O module 20 comprises input terminals 21 to be wired to a sensor device. The I/O module 20 is composed of a base part 22 (bottom), comprising the input terminals 21, and of an electronic part 23 (top) detachable from the base part 22. Power supply module 40 is connected to an auxiliary power supply 41. Additional modules that are not depicted, but that might nevertheless be present in a real IED, comprise a redundant power supply module, a communication module as a gateway for communicating signals to a substation bus, and further binary or analogue Input/Output modules.

FIG. 2 depicts an IED 10 with a function coding or activation key 34 engaged in the base part 32 of the processing module 30. The key 34 comprises, on its exterior, a visible code of the functionality enabled by the key. Such a coding may be established by colours, graphical symbols or IEC 61850 Logical Node designations related to the enabled functions.

The inter-module backplane 12 is provided for communication between the modules. Inter-module communication can be done electrically through the backplane with the use of a standard serial communication like USB, CAN, LIN, RS485, ASI, I2C, One-Wire, SPI or similar technologies. Optical or wireless communication based on suitable waveguides can also be used. The communication between the modules can be further achieved by modulating the communication signal on the supply lines, by means of power line communication.

A conventional Current Transformers (CT) generates a signal of 1 A as long as a nominal current flows through the power line to which the CT is attached. This signal is further transformed by a matching transformer that is generally part of an input module. However, bulky matching transformers represent an obstacle to smooth and uniform modularization, i.e. they set a limit to miniaturization, and therefore may be shifted away from the input module and integrated in the CT. Alternatively, the conventional CT may be substituted altogether by a non-conventional current sensor.

Advantageously, in a kind of “hot plug-in” operation, additional modules are added to the IED while the latter is active and running. The additional modules are placed on the mechanical support and connected to the power supply module, while the segmented backplane is extended automatically. The additional module inserted announces its presence to or is detected by the controller of the inter-module bus, and following proper addressing its module functionality is made available to the IED.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF DESIGNATIONS

10 Intelligent Electronic Device (IED)
11 mechanical support
12 backplane
20 I/O module
21 input terminals
22 base part
23 electronic part
30 processing module
32 base part
34 function activation key
40 power supply module
41 auxiliary power supply

What is claimed is:

1. An Intelligent Electronic Device (IED) for Substation Automation (SA) or Distribution Automation (DA) systems, comprising an input module for receiving a signal indicative of a condition of a high or medium voltage power line and a processing module for digitally processing the signal,
wherein the input module and the processing module are individually mountable on a mechanical support, and wherein the input module and the processing module comprise dedicated housings that, when the modules are mounted on the mechanical support, together form a housing of the IED.

2. The IED according to claim 1, wherein it comprises an input module with a voltage isolation between a signal input terminal and Protective Earth (PE) in excess of 2 kV.

3. The IED according to claim 1, wherein it comprises a segmented backplane for inter-module communication.

4. The IED according to claim 1, wherein a module consists of a base part mountable on the mechanical support and an electronic part detachable from the base part.

5. The IED according to claim 1, wherein the functions of the processing module are enabled by means of a coding key.

6. The IED according to claim 5, wherein the key is coded for visual inspection by means of a colour code or by means of a graphical symbol or Logical Node designating the enabled function.

7. The IED according to claim 1, wherein an IEC 61850 Logical Node (LN) designating a functionality performed by a particular module of the IED is allocated to said particular module.

8. An input module to be used in a modular Intelligent Electronic Device (IED) for Substation Automation (SA) or Distribution Automation (DA) systems, having a voltage isolation in excess of 2 kV between a signal input terminal and Protective Earth (PE).

9. An intelligent electronic device for automation systems, comprising:
an input module for receiving a signal indicative of a condition of a high or medium voltage power line;
a processing module for digitally processing the signal; and
a mechanical support, wherein the input module and the processing module are individually mountable on the mechanical support to form a housing of the intelligent electronic device.

10. The intelligent electronic device according to claim 9 being for substation or distribution automation systems.
